(19) United States
(12) Patent Application Publication
(10) Pub. No.: US 2012/0021242 A1
(43) Pub. Date: Jan. 26, 2012

(54) WALL FACING PANEL

(76) Inventor: Andrey Vilenovich Lyubomirskiy, Moscow (RU)

(21) Appl. No.: 13/138,821

(22) PCT Filed: Mar. 29, 2010
(86) PCT No.: PCT/RU2010/000143

§ 371 Date: Sep. 29, 2011

(30) Foreign Application Priority Data
Mar. 31, 2009 (RU) 2009111482

(51) Int. Cl. B32B 3/30; B32B 15/04; B32B 15/00

(52) U.S. Cl. 428/600; 428/172

(57) ABSTRACT

A wall facing panel includes a metal base and an outer layer with the thickness d₁, on the front face of which there are elements making up a design with textured structure containing convex elements and concaves, with an interlayer with the thickness d₂=0.005−300 mm; the textured design formed by the elements features convex elements with a maximum diameter of 0.01 mm to 25 mm and concaves with a width of 0.01 mm to 25 mm and a depth not exceeding 0.95 d₁=0.02−5.0 mm; the textured design is formed in conformity with the condition where S_{conv}/S_{conc}=0.1−19.0 where S_{conv} is the combined area of the convex elements, and S_{conc} is the combined area of the concaves; the concaves can be filled with hardened material.

This invention is for improvements in or relating to the design of wall facing panels with textured surface and can be used in products designed for both indoor and outdoor wall panelling.

There is the decorative panel [1] which has a metal base and a decorative element in the form of a stencilled printed design with a tin layer in between the metal base and the decorative element; the tin layer can be, for example, anodized coating applied to the metal base, and the area occupied by the decorative coating accounts for 50 per cent of the base.

There is also the functional and decorative wall panel [2] consisting of a flat metal sheet base, which is fastened to the wall, affixed with fixture elements to the functional and decorative elements on the outer surface of the wall panel; of the decorative layer on the outer side of the wall panel fastened to the base; and of the elastic padding built into the inner side of the panel; the decorative layer is made of a sheet polymer material; the elastic padding is made of flexible sheet material; in the decorative layer and in the base there are apertures spaced at regular intervals from each other along the vertical and horizontal axes; the fixture elements for the functional and decorative elements have hold-down heads fixed to the inner side of the wall panel; the said apertures have a profile that allows for easy insertion of the head of the fixture element into the front side of the wall panel and for the hold-down of the fixture element by the said head from the inner side of the wall panel; the wall panel is divided into sections that are abutted closely to one another on their flanks during the assembly of the wall panel.

The undesirable feature of the prior art panels [1,2] is their structural complexity caused by the fact that they are not single-layer.

There is the metallic wall panel which is a rectangular metal sheet with its edges deflected along the entire perimeter of the sheet, making an acute angle to its front side with a decorative relief; the decorative relief is made by the rectilinear and/or curvilinear elongated ledges (collars) created by high-pressure treatment of the sheet material and positioned symmetrically to the point of intersection of the diagonals of the front surface; and the height of the elongated ledges is more than the thickness of the metal sheet [3].

The undesirable feature of the aforesaid metallic wall panel is that it has low performance characteristics. Indeed, applying high-pressure treatment to the sheet material to create the decorative relief on the front surface of the panel with the height of the elongated ledges bigger than the thickness of the metal sheet puts tight restrictions on the thickness of the metal sheet and the mechanical properties of the material it is made of. To manufacture the prior art metallic wall panel, it is not possible to use high-performance metal sheets with a thickness of over 0.8 mm made of high-strength alloy steel with high anticorrosion properties and mechanical strength.

There is also the metallic wall panel taken as the prior art and having a rectangular aluminium base, on the front face of which there are ledges made of natural stone granules glued to the base.

The undesirable features of the prior art engineering solution are the low durability of the metallic wall panel and its low performance indicators since the prior art engineering solution does not assure the high durability of the metallic wall panel.

Closest to the proposed technical solution in its technical spirit is the prior art metallic wall panel [5] which consists of a stainless-steel metal base with decorative elements on its front face; the decorative elements are made in the form of concaves on its front face filled with dye of appropriate colour either on a level with or no more than 0.14 mm above the front face level by the powder coating method. (Patent of the Russian Federation No. 66383; IPC E04F 13/12, dated 16 Nov. 2006.)

The prior art technical solution is limited in its use due to the simplified fabrication technology (using the powder coating method for filling the concaves with dye either on a level with or no more than 0.14 mm above the front face level) which makes it impossible to achieve high quality and create designs on the product in a wide range of product indicators and ensure that the product possesses high consumer properties.

An object, realised through the implementation of the designed product, is to create a new type of wall panels.

The technical result obtained through the implementation of the designed product is the creation of a dirt-resistant vandal-proof wall panel which could preserve its consumer properties over a longer period of time.

To achieve the said technical result in accordance with the first embodiment, provided is the design of a wall panel with a metal base and an outer layer with the thickness d; on the front face of the outer layer there are elements making up a textured design pattern featuring convex elements and/or concaves and an interlayer with the thickness d₂=0.005−300 mm; the design pattern created by the said elements contains the convex elements with a maximum width of 0.01 mm to 25 mm across, and the concaves with a width of under 0.95d₁ where d₁=0.02−5.0 mm; the textured design pattern is created in conformity with the condition where S_{conv.}/S_{conc}=0.1−19.0 where S_{conv.} is the combined area of the convex elements, and S_{conc} is the combined area of the concaves.

In accordance with the preferable embodiment, in case the metal base is made of stainless steel, its thickness is d1=0.01−5.0 mm. The outer layer may also be made of titan.

The interlayer is made of a polymer or an adhesive layer and/or of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene and/or polyurethane and/or polysterol with the addition of silica sand or mineral fibres and/or of foam.

The metal base may be made of stainless steel with a thickness of d₃=0.1−5.0 mm or an aluminimun alloy with a thickness of d₃=0.1−5.0 mm or carbon steel with a zinc coating on the back side of the base, and lacquer coating on the back side of the base.

To achieve the said technical result in accordance with the second embodiment, provided is the design of a wall panel with a metal base and an outer layer with a thickness d₁; on the front face of the outer layer there are elements making up a textured design pattern featuring convex elements and/or concaves and an interlayer with the thickness d₂=0.005−300 mm; the design pattern created by these elements contains the convex elements with a maximum width of 0.01 mm to 25 mm, and the concaves with a width of under 0.95d₁ where d₁=0.02−5.0 mm and filled with a hardened medium; the design pattern is created in conformity with the condition where S_{conv.}/S_{conc}=0.1−19.0 where S_{conv.} is the combined area of the convex elements, and S_{conc} is the combined area of the concaves.

The second embodiment of the wall panel is different from the first embodiment in that the concaves are filled with a hardened medium.

Polymers or a composite material or dye are used as a hardened medium for filling the concaves of the textured surface.

The said technical result is achieved in the two embodiments of the provided wall panel by choosing between the three texture design options:

the texture of the surface features regularly spaced convex elements and concaves on the front face of the panel which make up an ornament;

the texture of the surface features randomly spaced convex elements and concaves on the front face of the panel which make up a chaotic design pattern;

the texture of the surface is a mix of regularly and randomly spaced convex elements and concaves on the front face of the panel that make up a pattern that features groups of convex and concave elements positioned in between the elements of the ornament.

During the development of the wall panel design, it was experimentally deduced that the width and the depth of the ledges and cavities of the relief-textured design are of key importance for this type of wall panels.

The tests and the research have revealed that the minimum possible width that is desirable from the economic point of view is 0.01 mm. Further reduction of the width is not desirable because it is difficult for the human eye to discern such small objects. Furthermore, from the technological point of view, cavities with a width of less than 0.01 mm can be produced by applying such a costly technique as photolithography. The objects larger than 0.01 can be made by inexpensive techniques, like tampon printing.

The use of micro-relief with the said dimensions filled with dyed medium (dye, dyed composite) makes it possible to protect the aforesaid dyed medium in the relief cavities from the damage that solid bodies may cause. In this case, the metallic ledges encircling the polymer perform the protective function. The smaller the width of the cavity filled with the dyed medium is, the smaller the chances are that the dyed medium will be damaged in the process of use. Usually, in a city environment, vandals more frequently use metallic coins, lock keys, less frequently penknives, i.e. the things that every man has at his disposal in public places.

Below are the specifications of coins:
the ten-kopek coin has a diameter of 17.5 mm and a thickness of 1.1 mm; made from a copper-base alloy.
the fifty-kopek coin has a diameter of 19.4 mm and a thickness of 1.4 mm; made from a copper-base alloy.
the one-rouble coin has a diameter of 20.5 mm and a thickness of 1.3 mm, made from a steel-base alloy.
the two-rouble coin has a diameter of 23 mm and a thickness of 1.8 mm; made from a steel-base alloy.
the two-rouble coin has a diameter of 25 mm and a thickness of 1.8 mm; made from a steel-base alloy.

The analysis of the geometric dimensions and the materials used in the production of the coins shows that the small-denomination coins of 10 and 50 kopeks made from soft copper-base alloys will not cause considerable damage to the decorative coatings of the panels. Moreover, the small size of the coins will not allow a vandal, without devoting a considerable physical effort, to have a firm grip on the coin by his thumb and index finger to ensure a significant part of the coin protrudes from in between the fingers. However, a vandal can easily have a firm grip on the coins with denominations of 1, 2 and 5 roubles between his fingers, in particular the five-rouble coin which has a diameter of 25 mm and a thickness of 1.8 mm.

During the testing of the relief characteristics, experiments were conducted with textured-surface sheet materials; the textured surface featured convexes and concaves, with the concaves filled with polymer powder paints based on the epoxy resin [symbol] -20 with a curing temperature of around 200° C. in the oven for five minutes. The width of the cavities in the relief used in the test varied from 0.01 mm to 50 mm. The relief cavities were either fully or half filled with the hardened dye. The force applied to the coin was within the range of 5 to 10 kg. The generatrix of the coin had a knurled profile.

Taking into account that the dye has a certain hardness which depends on the chemical composition of the binding agent (epoxide, polyester, polyurethane), it is evident that the value of resistance to the process of cutting of the surface by the coin changes. Moreover, the composition of dyes often includes fillers such as glass micro powder which have a high hardness value. In addition, the fact was taken into consideration that not all vandals can scratch the surface of a panel by a blunt coin for a long time, because it requires a strenuous physical effort. There is a need to bear in mind that the force of cutting as a coin scratches the cavities of the decorative relief should be huge so as to “get” to the bottom of the dyed cavity (filled with a polymer or a composite).

Numerous experiments conducted with the five-rouble coin have revealed that the biggest permissible width of the relief is 25 mm.

In other words, the optimal width of the cavity filled with dye is within the range of 0.01 mm to 25 mm.

In addition, it should be noted that the wall panel has another important consumer feature, which is that scratches are unnoticeable.

During the course of tests, it has been shown that a scratch on the dyed metal becomes noticeable when there appears a sharp contrast between the dyed and the undamaged surface and the gleam of the bear metal surface. If as a result of an act of vandalism a gleam of bear metal becomes visible on the monotonously dyed surface, a man subconsciously understands that there is a scratch in that place. With a width of less than 25 mm such scratches will be fewer in number as their length is limited to the same 25 mm. If scratches do appear, these will not be lines but rather barely visible specks instead.

In addition, the coating itself is an interlacing (from the point of view of the observer who does not have the knowledge of the composition and structure of the coating) of dyed and non-dyed patches some of which have a certain colour. All other patches are gleams of the metal surface and, above all, stainless steel. For a lay observer without special optical tools, it would be difficult to discern whether a gleam comes from an non-dyed patch, a ledge of the decorative relief or from a small scratch in the relief cavity which appeared as a result of an act of vandalism.

With a width of the relief elements ranging between 0.01 mm to 25 mm, fingerprints become invisible as well; fingerprints are one of the most common causes of dirt smearing a polished surface.

With the given width of the relief, it is easy to clear it of dust and other types of dirt.

The following are the important factors that influence the depth of the relief:

the quality of the dyed relief filler to hide the metal surface (to ensure the metal surface does not shine through the layer of the dyed filler). During the course of tests, it has been found that you can use a flat layer of the coloured filler with a thickness of 20-1200 micron.
under the impact of sun rays and above all ultraviolet, the relief filler—the dye—becomes less thick due to the destruction of the colouring agent's molecules and sublimation of the results of destruction of macromolecules;
reducing the depth of the relief while preserving the performance characteristics of the wall panel makes it possible to reduce the thickness of the panel, which leads to a reduction of its cost due to the decrease in the mass of the material, simplification of the panel fabrication technology, and the fact that it becomes easier to fasten the panel to the wall;
the dimensions of the fillers of the dyed matter. It has been found in the course of tests that the depth of the relief should be between 2 to 4 times more than the diameter of the biggest particle of the filler.

Taken the aforementioned into account, a series of experiments was conducted which revealed that the relief depth must not exceed the value of 0.95d where d stands for the thickness of sheet material.

The experiments to study the discernibility of scratches, fingerprints and to clean the surface have showed that a decorative design must be made in accordance with the following condition: S_{conv.}/S_{conc}=0.05−19.0 where S_{conv.} is the combined area of the convex elements, and S_{conc} is the combined area of the concaves, with the metal base having a thickness of d=0.02−5.0 mm.

The spirit of the invention of the provided wall facing panel is illustrated in the drawings:

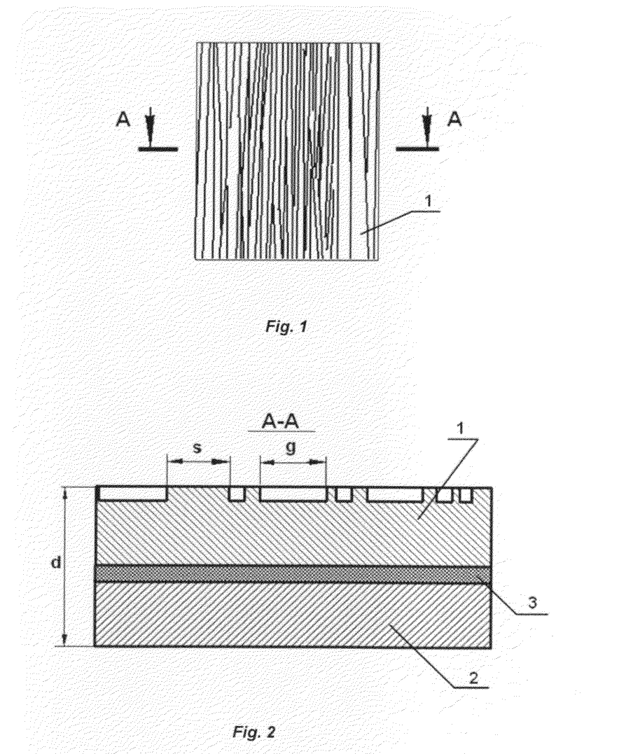

FIG. 1 shows a fragment of the metallic wall panel on the front face of the wall panel in accordance with the first embodiment (concaves are not filled with hardened material);

FIG. 2 shows the cross-section along the panel A-A showed in FIG. 1;

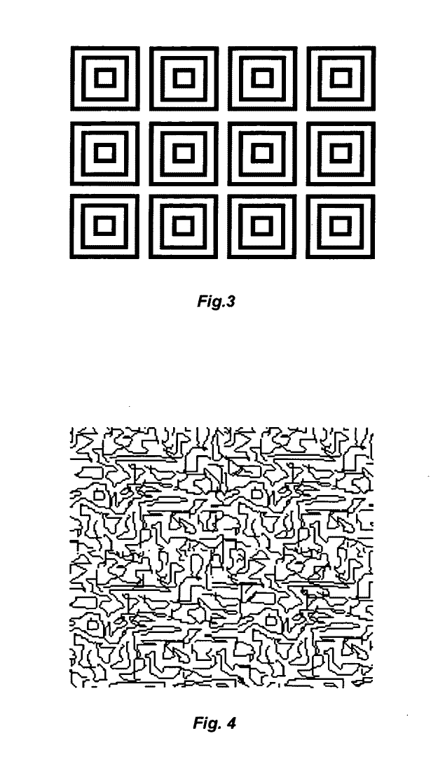

FIG. 3 shows the relief design on the front face of the wall panel with the regular spacing of the relief elements following the first design option (concaves are not filled with hardened material);

FIG. 4 shows the relief design featuring chaotically spaced relief elements on the front face of the wall panel following the first design option (concaves are not filled with hardened material);

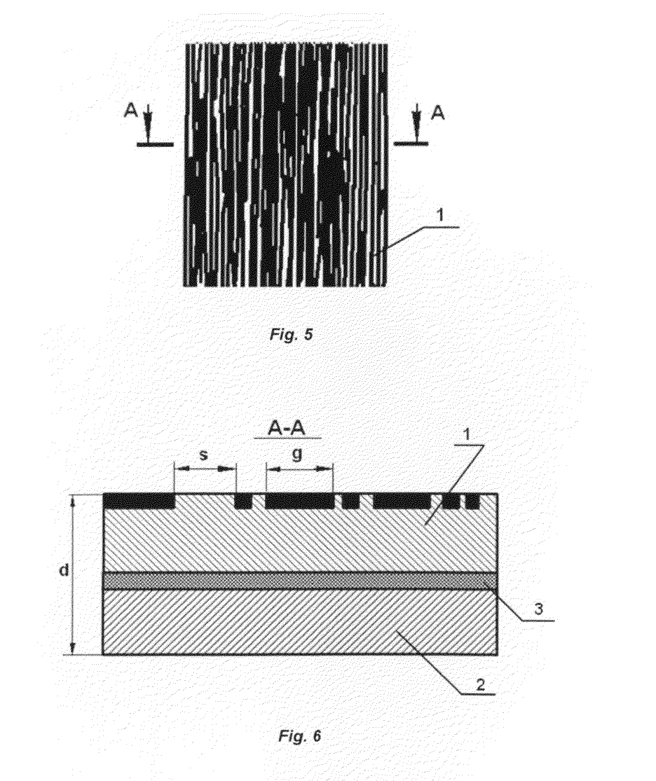

FIG. 5 shows the relief design on the front face of the wall panel following the second design option (concaves are not filled with hardened material);

FIG. 6 shows the cross-section along the panel A-A showed in FIG. 5;

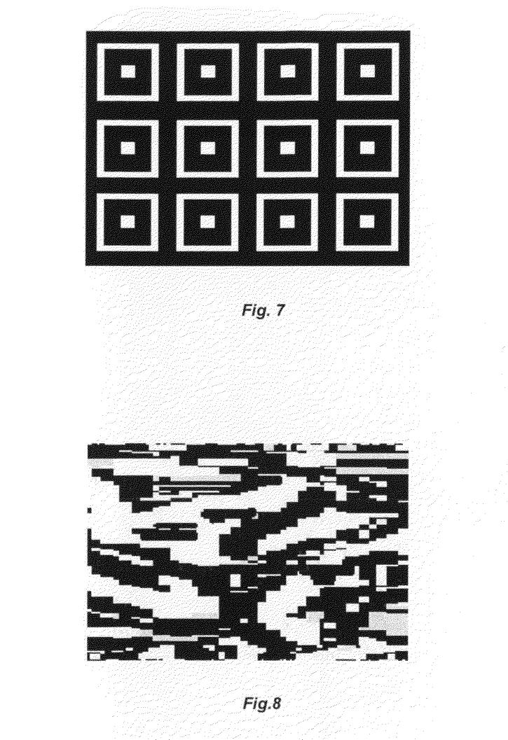

FIG. 7 shows the relief design on the front face of the wall panel featuring the regularly spaced relief elements following the second design option (concaves are filled with hardened material);

FIG. 8 shows the relief design on the front face of the wall panel featuring the chaotically spaced relief elements following the second design option (concaves are filled with hardened material);

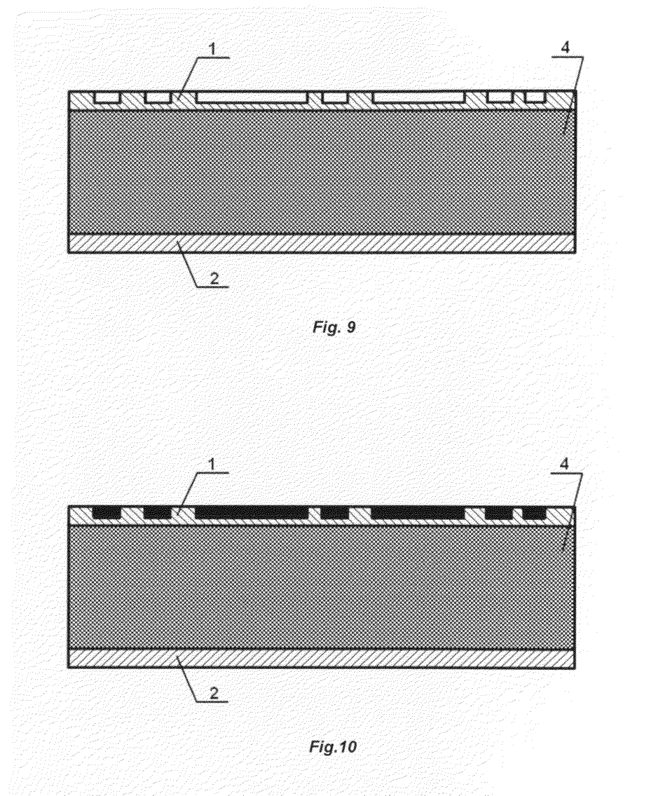

FIG. 9 shows the cross-section of the panel following the first design option with an interlayer of foam (concaves are not filled with hardened material);

FIG. 10 shows the cross-section of the panel following the second design option with an interlayer of foam (concaves are filled with hardened material);

The wall facing panel (FIG. 2, 6, 9, 10) has the outer layer 1 with a thickness d₁ on the front face of which there are elements making up a textured design containing convex elements and/or concaves, the base 2 and the interlayer 3 with the thickness d₂=0.005−300 mm and the base 2 with the thickness d_{3.}

The convex elements in the textured design (FIG. 2, 3, 4, 9, 10) have a maximum diameter of 0.01 mm to 25 mm, and concaves have a width of 0.01 mm to 25 mm and a depth under 0.95d₁ where d₁=0.02−5.0 mm; the textured design is made in accordance with the condition: S_{conv.}/S_{conc}=0.1−19.0 where S_{conv.} is the combined area of the convex elements, and S_{conc} is the combined area of the concaves.

The said ratios of the geometric parameters of the convex and concave elements make it possible to create relief designs (from simple designs and ornaments to complex drawing-type designs), thus making it possible to expand the area of use of the proposed wall facing panel.

The provided wall panel is fabricated as follows.

The outer decorative layer 1 has the thickness d₁=0.02−5.0 mm and is made of stainless steel, aluminium alloy, or titan.

The metal base 2 (FIG. 1) is made of stainless steel with a thickness of d₃=0.1−5.0 mm, or of an aluminium alloy with a thickness of d₃=0.01=5.0 mm, or of zinc-coated carbon steel on the back side of the base and lacquer coating on the back side of the base.

The interlayer (FIG. 2, 6, 9, 10) is made of polymer or an adhesive layer and/or of chipboard and/or fireboard and/or MDF and/or paper laminate and/or plywood and/or polymer material, for example, of PolyVinylChloride and/or epoxide and/or polyester and/or polyurethane and/or polycarbonate and/or acryl and/or polystyrene and/or polyethylene and/or composite material with a hardened polymer-based binding medium, for example, of glass-fibre plastic and/or coal plastic and/or polymers with mineral or layered fillers, for example, of polyethylene and/or polyurethane and/or polysterol with the addition of silica sand or mineral fibres and/or of foam. Furthermore, the interlayer can be made of fire-proof materials, for example, of silicate cotton and/or glass cotton and/or concretes and/or sheet fibre concrete and/or asbestos cement materials and/or foam glass and/or fibrous and/or foam materials and other non-combustible materials, and of self-extinguishing materials.

A relief design on the outer layer 1 with the given geometric parameters can be made, for example, by chemical etching; prior to etching, a protective mask must be applied using the template web printing technique; the patches unprotected by the mask are exposed to the impact etching solution; as a result, a relief design is created in the metal tape with the concaves etched to the aforementioned value.

Then (the second embodiment of the panel) the concaves of the relief design are filled with a liquid component which hardens over time due to being exposed to, for example, ultraviolet and/or infrared radiation.

The design is created in conformity with the following condition: S_{conv.}/S_{conc}=0.05−19.0 where S_{conv.} is the combined area of the convex elements, and S_{conc} is the combined area of the concaves.

The indicated ratios of the parameters obtained as a result of a series of lengthy experiments make it possible to create relief designs of virtually any complexity (see FIG. 1, 3, 4). Thus, the design features distinguishing the provided wall panel from the prior art are dependant, through the relation of cause and effect, on the attainable technical result, which is the creation of a dirt-resistant vandal-proof wall panel which could preserve its consumer properties over a longer period of time.

The fastening of the panel to the surface that needs panelling is done by the prior art methods: the panels are glued using an adhesive composition or fastened by fixture elements.

The outer layer of the wall panel is to be fabricated preferably from stainless steel (brands X18H25C2, X18H9, 08X18H10, 08X18H9T, 12X18H9, 12X18H9T, and others) with a thickness between 0.03 to 3.0 mm.

The metal base is made preferably of stainless steel of the aforementioned brands, or of an aluminium alloy or a sheet of aluminium alloys of the brands Aκ-1, Aπ-7, Aπ-8, Aπ-9, or of carbon steel or zinc-coated carbon steel.

The materials used in this wall panel are highly resistant to external impact and ensure a long operating life of the product.
Information sources:
1. Patent of the Russian Federation No. 2780, IPC B44C 5/04, 1995.
2. Patent of the Russian Federation No. 54338, IPC B44F 5/00, 2006.
3. Patent of the Federal Republic of Germany No. 2903359, IPC B44F, B44C1980/04, 1980.
4. Patent of the Federal Republic of Germany No. 3929761, IPC B44F, 1991.
5. Patent of the Russian Federation No. 66383; IPC E04F 13/12, 2006.

1-29. (canceled)

30. A wall panel, comprising a metal base and an outer layer with a thickness d₁, on a front face of which there are elements making up a design with textured structures including elements selected from the group consisting of convex elements, concaves and both, wherein the wall panel has an interlayer with a thickness d₂=0.005−300 mm; wherein the textured design formed by the elements includes the convex elements with a maximum diameter of 0.01 mm to 25 mm and the concaves with a width of 0.01 mm to 25 mm and a depth not exceeding 0.95 d₁=where d₁ 0.02−5.0 mm, wherein the textured design is formed in conformity with a condition where S_{conv}/S_{conc}=0.1−19.0 where S_{conv} is a combined area of the convex elements, and S_{conc} is a combined area of the concaves.

31. The wall panel as defined in claim 30, wherein the outer layer is composed of a material selected from the group consisting of stainless steel, aluminum alloy, and titan.

32. The wall panel as defined in claim 30, wherein the interlayer is composed of a material selected from the group consisting of a polymer, an adhesive layer, chipboard, fireboard, MDF, paper laminate, plywood, and polymer material selected from the group consisting of PolyVinylChloride, epoxide, polyester, polyurethane, polycarbonate, acryl, polystyrene, and polyethylene, composite material with a hardened polymer-based binding medium selected from the group consisting of glass-fiber plastic and coal plastic, polymers with mineral or layered fillers selected from the group consisting of polyurethane and polysterol with addition of a material selected from the group consisting of silica sand, mineral fibers, and foam.

33. The wall panel as defined in claim 30, wherein the metal base is of a material selected from the group consisting of stainless steel with a thickness of d₃=0.1−5.0 mm and carbon steel.

34. The wall panel as defined in claim 30, wherein the metal base is provided with a coating selected from the group consisting of zinc coating on a back side of the base, and a lacquer coating on the back side of the base.

35. The wall panel as defined in claim 30, wherein the textured design features have a spacing selected from the group consisting of regular spacing of the convex elements and concaves on the front face of the panel thus producing an ornament, random spacing of the convex elements and the concaves thus producing a chaotic design pattern, and a mix of regular and random spacing of the concave and convex elements on the front face of the panel, which forms a design pattern featuring groups of the convex elements and concaves positioned in between the elements of the ornament.

36. A wall panel, comprising a metal base and an outer layer with a thickness d₁, on a front face of which there are elements making up textured design featuring convex elements and concaves with structure, wherein the design formed by elements has an interlayer with a thickness d₂=0.005−300 mm; wherein the textured design formed by the elements includes the convex elements with a maximum diameter of 0.01 mm to 25 mm and the concaves with a width of 0.01 mm to 25 mm and a depth not exceeding 0.95 d₁=0.02−5.0 mm, wherein the textured design is formed in conformity with a condition where S_{conv}/S_{conc}=0.05−19.0 where S_{conv} is a combined area of the convex elements, and S_{conc} is a combined area of the concaves.

37. The wall panel as defined in claim 36, wherein the outer layer is composed of a material selected from the group consisting of a polymer, adhesive layer, chipboard, fireboard, MDF, paper laminate, plywood and polymer material, selected from the group consisting of PolyVinylChloride, epoxide, polyester, polyurethane, polycarbonate, acryl, polystyrene and polyethylene, composite material with a hardened polymer-based binding medium selected from thee group consisting of glass-fiber plastic and coal plastic, polymers with mineral or layered fillers, selected from the group consisting of polyethylene, polyurethane, and polysterol with addition of a material selected from the group consisting of silica sand, mineral fibers and foam.

38. The wall panel as defined in claim 36, wherein the metal base is composed of a material selected from the group consisting of stainless steel with a thickness of d₃=0.1−5.0 mm, aluminum alloy with a thickness of d₃=0.1−5.0 mm, and carbon steel.

39. The wall panel as defined in claim 36, wherein the metal base has a coating selected from the group consisting of a zinc coating on a back side of the base and a lacquer coating on the back side of the base.

40. The wall panel as defined in claim 37, wherein a material selected from the group consisting of polymers, a composite material and a dye is used as a hardened medium.

41. The wall panel as defined in claim 37, wherein the texture of the surface features includes a texture selected from the group consisting of regularly spaced convex elements and concaves on the front face of the panel which make up an ornament, randomly spaced convex elements and concaves on the front face of the panel which make up a chaotic pattern, and a mix of regularly and randomly spaced convex elements and concaves on the front face of the panel that make up a pattern that features groups of convex and concave elements positioned in between elements of the ornament.
